(19) United States
(12) Patent Application Publication
(10) Pub. No.: US 2016/0291962 A1
(43) Pub. Date: Oct. 6, 2016

(54) SYSTEM, METHOD OF CONTROLLING THE SAME, AND NON-TRANSITORY COMPUTER-READABLE STORAGE MEDIUM

(71) Applicant: CANON KABUSHIKI KAISHA, Tokyo (JP)

(72) Inventor: Takumi Michishita, Nagareyama-shi (JP)

(21) Appl. No.: 15/079,440

(22) Filed: Mar. 24, 2016

(30) Foreign Application Priority Data
Apr. 6, 2015 (JP) 2015-077948

(51) Int. Cl. G06F 9/445

(52) U.S. Cl. CPC G06F 8/65

(57) ABSTRACT

A system including a plurality of units each including a processing unit that operates using firmware, and a storage unit that stores the firmware, comprises: a control unit that controls power supply to each of the plurality of units; a first specifying unit that specifies, based on updating data, a unit that should update the firmware; a second specifying unit that specifies, out of the plurality of units, a unit that needs power supply when updating the firmware of the specified unit; and an updating unit that updates, using the updating data, the firmware stored in the storage unit of the unit specified by the first specifying unit, wherein when updating the firmware, the control unit supplies power to the unit specified by the second specifying unit as the unit that needs power supply.

### BACKGROUND OF THE INVENTION

1. Field of the Invention

The present invention relates to a system, a method of controlling the same, and a non-transitory computer-readable storage medium and, more particularly, to a power control method at the time of firmware updating processing in an image forming apparatus.

2. Description of the Related Art

When the firmware of an image forming apparatus such as a multi-function peripheral needs to be updated to improve functions or cope with a failure, the updating is required to be performed efficiently and safely.

The image forming apparatus includes the CPU of a main unit control unit that controls the entire image forming apparatus, and the CPUs of optional units that individually control optional functions such as FAX and finishing functions. It is necessary to store firmware for each optional unit, and there exists a case in which the pieces of firmware are separately updated.

In recent years, the number of electronic devices to be connected to program distribution servers via a network has been growing. When updating firmware, such an electronic device can automatically select and receive applicable firmware out of a number of pieces of firmware registered on the server side. For example, in Japanese Patent Laid-Open No. 2006-072761, a function of causing a portable terminal to periodically inquire of a server about latest firmware and automatically execute updating processing is implemented (see Japanese Patent Laid-Open No. 2006-072761).

Japanese Patent Laid-Open No. 2013-240946 proposes a technique of, when a power-saving state is set at the start of firmware updating, causing a system to cancel the power-saving state and transit to the power-saving state again after the end of updating. According to Japanese Patent Laid-Open No. 2013-240946, it is possible to supply necessary power and enable firmware updating without concern for the power-saving state before and after firmware updating.

Conventionally, to safely execute firmware updating, job processing is stopped, and the system is rebooted once. After that, a special operation state for updating is set, and firmware updating processing is performed. In a system formed from an image forming apparatus to which a plurality of optional units are attached, all units are powered on at the time of reboot. This is because depending on the hardware arrangement, it may be impossible to do complex power control immediately after power-on until the system for controlling power is booted. If power supply control during firmware updating processing is not taken into consideration, after reboot, the system always operates in a standby state in terms of power supply. As updating via a server is becoming popular, periodical firmware updating is also executed. If unnecessary units remain in the power-ON state during such updating, power is wastefully consumed, or an initial operation sound or vibration is generated.

In the technique of automatically downloading firmware from a server and performing updating processing, as in Japanese Patent Laid-Open No. 2006-072761, the firmware can automatically be obtained, for example, at a timing at which the user is not using the electronic device. However, a general electronic device rarely has a plurality of optional units connected, unlike an image forming apparatus. Hence, there is no mention of detailed power control during firmware updating.

In addition, the technique of returning from the power-saving state before and after firmware updating and returning to the power-saving state after, as in Japanese Patent Laid-Open No. 2013-240946, can optimize the power state before and after upgrading. However, there is no mention of power control on a unit basis during firmware updating. For this reason, the power-saving effect cannot be expected when the updating is frequently performed or when the updating processing takes time.

### SUMMARY OF THE INVENTION

According to one aspect of the present invention, there is provided a system including a plurality of units each including a processing unit configured to operate using firmware, and a storage unit configured to store the firmware, comprising: a power control unit configured to control power supply to each of the plurality of units; an obtaining unit configured to obtain updating data of the firmware; a first specifying unit configured to specify, based on the updating data, a unit that should update the firmware out of the plurality of units; a second specifying unit configured to specify, out of the plurality of units, a unit that needs power supply when updating the firmware of the unit specified by the first specifying unit; and an updating unit configured to update, using the updating data, the firmware stored in the storage unit of the unit specified by the first specifying unit, wherein when the updating unit is updating the firmware, the power control unit supplies power to the unit specified out of the plurality of units by the second specifying unit as the unit that needs power supply, and stops power supply to remaining units.

According to another aspect of the present invention, there is provided a method of controlling a system including a plurality of units each including a processing unit configured to operate using firmware, and a storage unit configured to store the firmware, and a power control unit configured to control power supply to each of the plurality of units, comprising: obtaining updating data of the firmware; specifying, based on the updating data, a unit that should update the firmware out of the plurality of units; specifying, out of the plurality of units, a unit that needs power supply when updating the firmware of the unit specified in the specifying the unit that should update the firmware; and updating, using the updating data, the firmware stored in the storage unit of the unit specified in the specifying the unit that should update the firmware, wherein when the firmware is being updated in the updating, the power control unit is caused to supply power to the unit specified out of the plurality of units in the specifying the unit that needs power supply as the unit that needs power supply and stop power supply to remaining units.

According to another aspect of the present invention, there is provided a non-transitory computer-readable storage medium storing a program that causes a computer to function as: a power control unit configured to control power supply to each of a plurality of units each including a processing unit configured to operate using firmware, and a storage unit configured to store the firmware; an obtaining unit configured to obtain updating data of the firmware; a first specifying unit configured to specify, based on the updating data, a unit that should update the firmware out of the plurality of units; a second specifying unit configured to specify, out of the plurality of units, a unit that needs power supply when updating the firmware of the unit specified by the first specifying unit; and an updating unit configured to update, using the updating data, the firmware stored in the storage unit of the unit specified by the first specifying unit, wherein when the updating unit is updating the firmware, the power control unit supplies power to the unit specified out of the plurality of units by the second specifying unit as the unit that needs power supply, and stops power supply to remaining units.

According to the present invention, it is possible to save power by appropriately controlling power supply to each unit during firmware updating.

Further features of the present invention will become apparent from the following description of exemplary embodiments (with reference to the attached drawings).

### BRIEF DESCRIPTION OF THE DRAWINGS

FIG. 1 is a block diagram showing an example of the hardware arrangement of an image forming apparatus according to the embodiment;

FIG. 2 is a block diagram showing an example of the software configuration of the image forming apparatus according to the embodiment;

FIG. 3 is a view showing an example of firmware files transferred from an external storage device according to the embodiment;

FIG. 4 is a block diagram showing an example of the configuration of power control according to the embodiment;

FIG. 5 is a flowchart of processing according to the embodiment;

FIG. 6 is a block diagram showing an example of the power supply state at the time of updating of the image forming apparatus according to the embodiment; and

FIG. 7 is a chart showing an image of power consumption according to the embodiment.

### DESCRIPTION OF THE EMBODIMENTS

Hereinafter, the embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

### First Embodiment

An embodiment to implement the present invention will be described below with reference to the accompanying drawings.

[Hardware Arrangement]

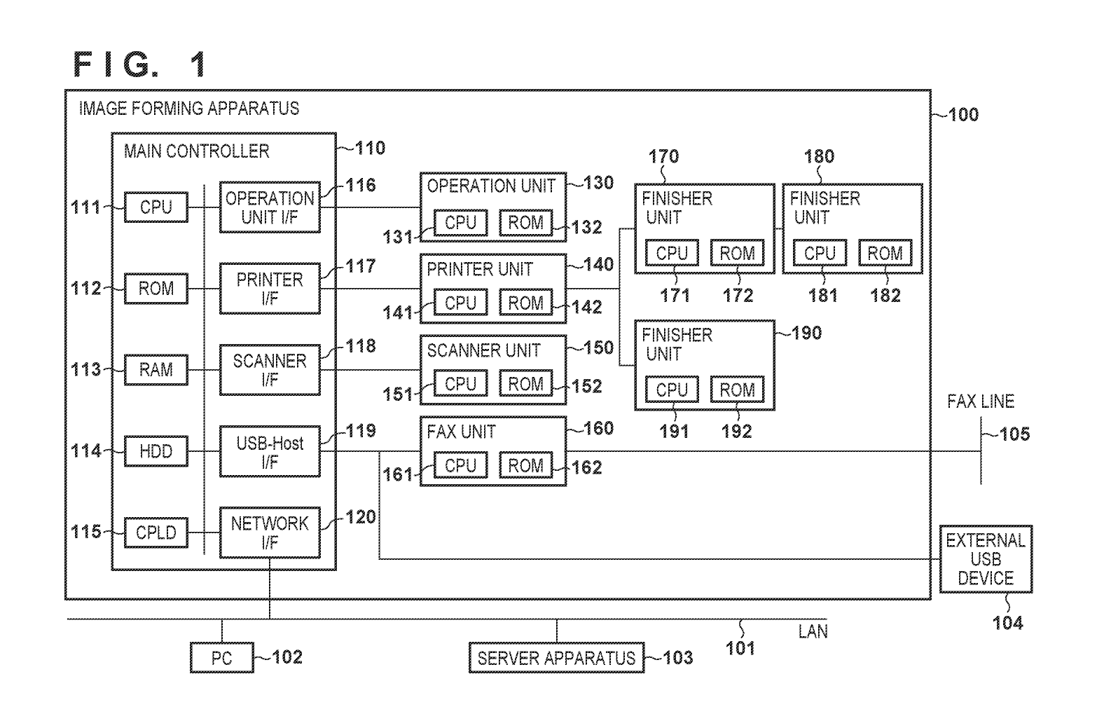

FIG. 1 is a block diagram showing an example of the hardware arrangement of an image forming apparatus 100 as a system according to the present invention. Referring to FIG. 1, a main controller 110 controls the entire image forming apparatus 100. The main controller 110 includes a CPU 111, a ROM 112, a RAM 113, an HDD 114, a CPLD (Complex Programmable Logic Device) 115, an operation unit I/F 116, a printer I/F 117, a scanner I/F 118, a USB-Host I/F 119, and a network I/F 120. In addition, the main controller 110 is connected, via the interfaces, to a plurality of units each including a CPU and a ROM. Each unit includes a CPU to control the operation of its own. The CPU of each unit reads out a program stored in the ROM of the unit and executes the program, thereby performing an independent operation in addition to an operation according to an instruction from the main controller 110.

The CPU 111 reads out a program for the main controller 110, which is stored in the ROM 112, to the RAM 113 and executes the program. The ROM 112 corresponds to a flash ROM or the like, and stores license and device configuration information and device information such as a firmware version.

The HDD 114 is a nonvolatile storage unit, and stores print data received from a PC 102 via the network I/F 120. Note that the programs to be executed by the CPU 111 include a print application program (not shown). The print application program converts the print data stored in the HDD 114 into image data printable by a printer unit 140. The HDD 114 also stores image data printable by the printer unit 140. The programs to be executed by the CPU 111 also include a scan application program. The scan application program causes a scanner unit 150 to read image data and transfer the read image data to the HDD 114. The HDD 114 stores the read image data.

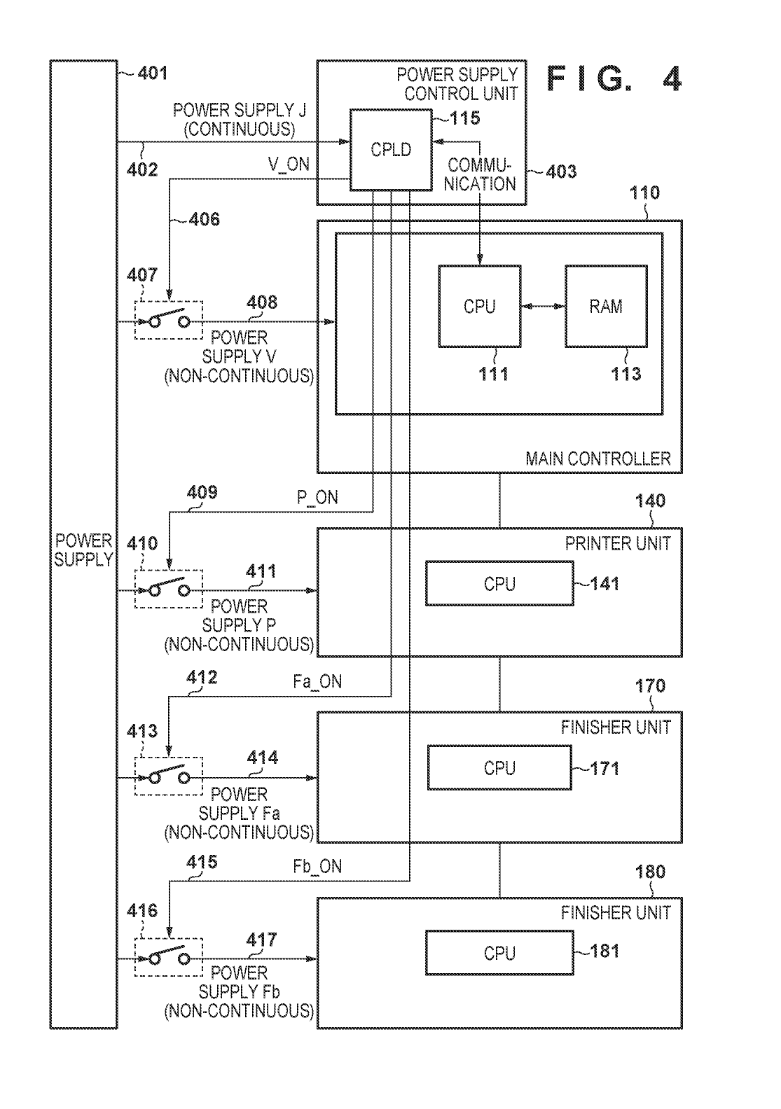

The CPLD 115 is preprogrammed to execute a desired operation concerning power control. The CPLD 115 communicates with the CPU 111, thereby controlling power supply to the units in addition to the main controller 110. An example of control of the supply of power from a power supply to the units will be described later with reference to FIG. 4.

The operation unit I/F 116 is an interface used to transmit an instruction input via an operation unit 130 by the user of the image forming apparatus 100 to the CPU 111. The operation unit I/F 116 also receives processing contents to switch contents to be displayed on the operation unit 130 from the CPU 111, and transmits the processing contents to the operation unit 130. Note that the operation unit 130 includes a liquid crystal display unit with a touch panel function, a keyboard (not shown), or the like, and can accept an instruction from the user.

The printer I/F 117 is an interface used to connect the main controller 110 and the printer unit 140. The printer unit 140 prints on a print medium such as paper based on image data transferred from the HDD 114 via the printer I/F 117.

Finisher units 170, 180, and 190 perform various kinds of finishing processing for the print medium printed by the printer unit 140. Examples of finishing processing are stapling for sheets, punching for sheets, saddle stitch binding, and trimming. The connection state of the various finisher units changes depending on the arrangement of the main body. The finisher units 170 and 180 may be connected in series, as shown in FIG. 1, or separately connected. Although not illustrated in FIG. 1, a conveyance path may be formed such that the print medium printed by the printer unit 140 is conveyed to the various finisher units in accordance with the finishing processing.

The scanner I/F 118 is an interface used to connect the main controller 110 and the scanner unit 150. The scanner unit 150 also functions as an input means for inputting image data, and reads an image on an original as image data using a line sensor formed from a CCD (Charge Coupled Device) or the like. The scanner unit 150 transfers the read image data to the HDD 114 via the scanner I/F 118. The image data transferred to the HDD 114 and stored can be printed by the printer unit 140. Copy processing can be performed by causing the printer unit 140 to print the image data read by the scanner unit 150.

The USB-Host I/F 119 is an interface used to connect the main controller 110 and a FAX unit 160. The FAX unit 160 performs FAX transmission via a FAX line 105 based on image data transferred from the HDD 114 via the USB-Host I/F 119. The FAX unit 160 also generates image data based on data received via the FAX line 105, and transfers the image data to the HDD 114 via the USB-Host I/F 119. Note that the image data stored in the HDD 114 is printed on a print medium such as paper by the printer unit 140, as described above. Note that the USB-Host I/F 119 can also be connected to an external USB device 104. Examples of the external USB device 104 are a USB memory and a USB keyboard (not shown). An updating file necessary for updating can also be transferred from the USB memory.

The network I/F 120 connects the main controller 110 to a LAN 101, and performs communication with the PC 102 on the LAN 101. The PC 102 is connected to the image forming apparatus 100 via the LAN 101, and can perform print data transmission, device operation via a web browser (not shown), firmware file transfer, and the like for the image forming apparatus 100.

The image forming apparatus 100 is also connected to a server apparatus 103 via the LAN 101, and can download an updating file necessary for firmware updating. A protocol used here by a means for downloading the updating file can be any one of HTTP (Hyper Text Transfer Protocol), FTP (File Transfer Protocol), and the like. Note that FIG. 1 shows an arrangement with the server apparatus 103 being connected on the LAN 101. However, the arrangement is not limited to this. For example, the image forming apparatus 100 may be connected to the server apparatus 103 on an external network such as the Internet.

In the server apparatus 103, a latest program necessary to update is always uploaded. The image forming apparatus 100 can obtain the latest program by a query. However, the image forming apparatus 100 may be not connected to the server apparatus 103 depending on its installation environment.

The operation unit 130, the printer unit 140, the scanner unit 150, the FAX unit 160, and the finisher units 170, 180, and 190 include CPUs 131, 141, 151, 161, 171, 181, and 191 and ROMs 132, 142, 152, 162, 172, 182, and 192, respectively. Although the scale is smaller than the CPU 111 and the ROM 112 of the main controller 110, each CPU can load a program stored in the ROM and control the device or communicate with another device. When upgrading firmware, programs stored in the ROMs 132, 142, 152, 162, 172, 182, and 192 can also be updating targets.

Note that the operation unit 130, the scanner unit 150, the FAX unit 160, and the finisher units 170, 180, and 190 are detachable in accordance with the application purpose because they are sometimes attached later as options or exchanged due to a failure or the like.

[Software Configuration]

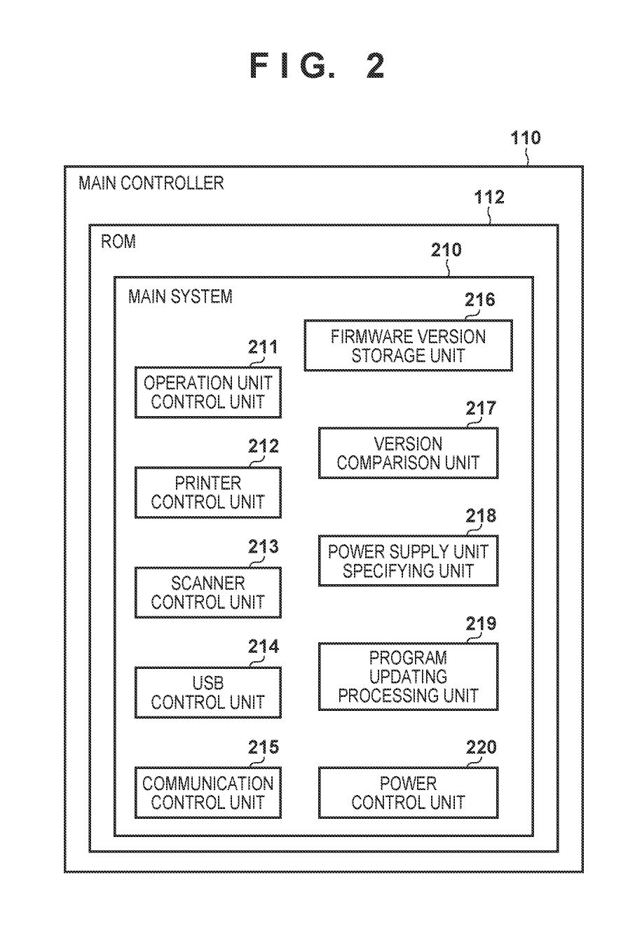

An example of the configuration of software executed by the CPU 111 of the main controller 110 will be described with reference to FIG. 2. Note that programs corresponding to processing units shown in FIG. 2 are assumed to be stored in the ROM 112 shown in FIG. 1.

In a main system 210, programs configured to implement various functions of the image forming apparatus 100 according to this embodiment are arranged. An operation unit control unit 211 controls the operation unit 130 via the operation unit I/F 116. A printer control unit 212 controls the printer unit 140 via the printer I/F 117. A scanner control unit 213 controls the scanner unit 150 via the scanner I/F 118.

A USB control unit 214 controls, via the USB-Host I/F 119, the external USB device 104 connected to the USB-Host I/F 119. When a USB memory is connected as the external USB device 104, the USB control unit 214 performs control associated with transfer processing of an updating file and updating information necessary for firmware updating from the USB memory. The transferred file is saved in the HDD 114.

A communication control unit 215 performs communication with the PC 102 or the server apparatus 103 via the network I/F 120. The communication control unit 215 also performs transfer processing of an updating file and updating information necessary for firmware updating via the LAN 101. The transferred file is saved in the HDD 114.

A firmware version storage unit 216 stores the versions of firmware stored in the ROM 112 of the main controller 110 and the ROMs 142, 152, 162, 172, 182, and 192 in the optional units connected to the image forming apparatus 100. The version information of firmware stored in each ROM is updated after completion of updating, stored by this part, and used for version comparison in the next updating.

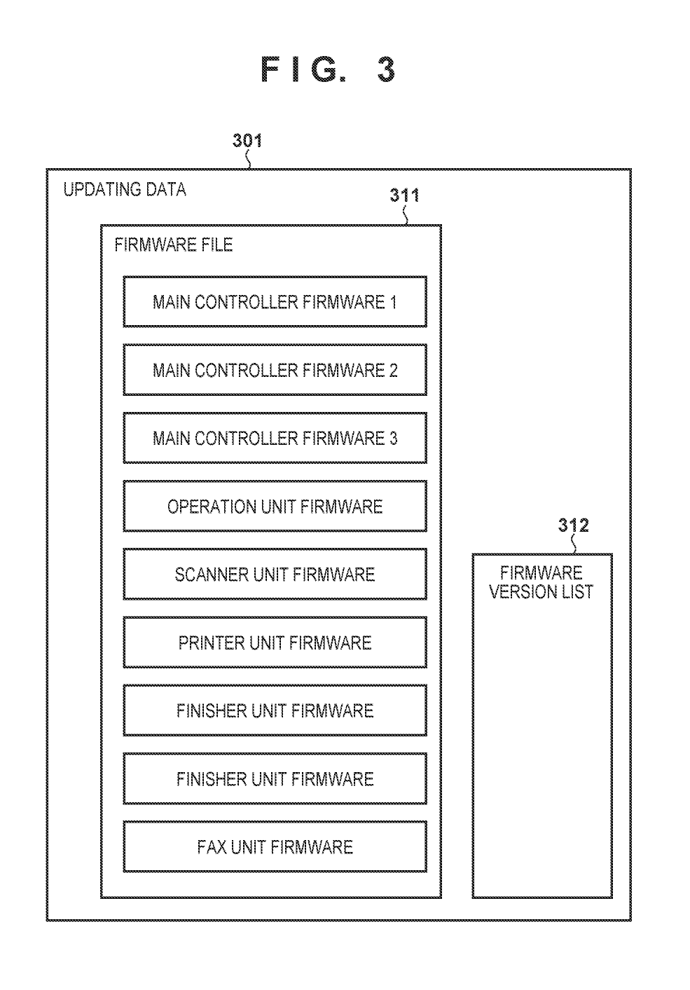

A version comparison unit 217 performs comparison processing between the version of a program in each ROM, which is stored in the firmware version storage unit 216, and a version described in a firmware version list saved in the HDD 114. The firmware version list will be described later with reference to FIG. 3.

A power supply unit specifying unit 218 specifies a unit to which power needs to be supplied at the time of firmware updating based on version information compared by the version comparison unit 217, the power dependence between the optional units, and the presence/absence of an external notification function.

A program updating processing unit 219 performs updating processing of a program stored in each ROM when the user has input a firmware upgrading execution instruction via the operation unit 130 or at a reserved upgrading time.

A power control unit 220 communicates with the CPLD 115 or each optional unit in accordance with the state of the image forming apparatus 100, and controls power supply of the image forming apparatus 100. The power control unit 220 can control power supply to each optional unit. If the image forming apparatus 100 is not used for a predetermined time, the power control unit 220 powers off unnecessary units and makes them transit to a power-saving state such as a power conservation mode or sleep mode. The control contents of the power control unit 220 and the CPLD 115 will be described later with reference to FIG. 4.

[Example of Data Structure]

FIG. 3 shows an example of the structure of data transferred from the external USB device 104, the PC 102, or the server apparatus 103 by the USB control unit 214 or the communication control unit 215.

Updating data 301 represents whole data transferred from an external storage device to the image forming apparatus 100. The updating data 301 includes a firmware file 311 and a firmware version list 312.

The firmware file 311 includes programs to be stored in the ROMs 112, 132, 142, 152, 162, 172, 182, and 192. As shown in FIG. 3, a program of a relatively large scale for, for example, the main controller may be divisionally transferred as a plurality of files (here, firmware 1 to 3 for the main controller). In this case, the updating targets can be minimized by comparing the differences. The firmware file 311 need not include firmware for all units of the image forming apparatus 100. The transfer data amount may be reduced by comparing versions to specify necessary data before transfer from the external storage device and then transferring the data.

The firmware version list 312 describes the versions of all files in the firmware file 311 included in the updating data 301. The version of firmware to be updated can be specified by referring to the firmware version list 312. The version comparison unit 217 compares the contents of the firmware version list 312 with a firmware version stored in the firmware version storage unit 216 to specify the version difference, thereby determining the updating target unit.

[Power Supply Arrangement]

FIG. 4 is a view for explaining the power supply arrangement of the image forming apparatus 100 shown in FIG. 1. The arrangement of a power supply 401 will be described below by exemplifying the main controller 110 and the printer unit 140 out of the optional units in the image forming apparatus 100.

Referring to FIG. 4, a power supply control unit 403 is a unit including the CPLD 115 in the main controller 110. Power is always supplied to the power supply control unit 403 via a power supply line J 402 that is a first power supply line. The power supply control unit 403 consumes only low power. Hence, the power supply control unit 403 is therefore always energized by the power supply 401 even in the power-saving state or shutdown state to do power control.

The CPLD 115 is preprogrammed to execute a desired operation to be described below. That is, a relay switch 407 is switched by an IO signal V_ON 406 that is a first power supply control signal. Accordingly, power is supplied from the power supply 401 via a power supply line V 408 that is a second power supply line, and feeding to the main controller 110 is controlled. In addition, a plurality of timer values are set by communication from the CPU 111. When the timer starts, the operation set by the CPU 111 is executed.

A relay switch 410 is switched by an IO signal P_ON 409 that is a second power supply control signal. Accordingly, power is supplied from the power supply 401 via a power supply line P 411 that is a third power supply line, and feeding to the printer unit 140 is controlled.

Relay switches 413 and 416 are switched by IO signals Fa_ON 412 and Fb_ON 415 that are third and fourth power supply control signals. Accordingly, power is supplied from the power supply 401 via power supply lines Fa 414 and Fb 417, and feeding to the finisher units 170 and 180 is controlled. In any case, the operation set by the CPU 111 of the main controller 110 is communicated, thereby causing the CPLD 115 to control each power supply control signal.

Power supply control of the entire image forming apparatus 100 is executed mainly by the power supply control unit 403. In some cases, control of the operations of the finisher units 170 and 180 is performed via the printer unit 140. For example, when updating the ROM 182 of the finisher unit 180, the printer unit 140 and the finisher unit 170 which serve as a path need to be ON. Hence, appropriate power control needs to be executed even for the units on the path. That is, the units to which power is to be supplied are specified in accordance with the connection configuration of the units and the position of the unit that should update the firmware.

Note that the configuration of power control using relay switches from the CPLD 115 is also employed for the optional units 140, 150, 160, and 190, like the units described with reference to FIG. 4. The contents are the same, and a description thereof will be omitted. That is, the same power supply control as the printer unit 140 is performed for the remaining optional units.

Note that feeding for each unit as shown in FIG. 4 can be implemented by, for example, turning off only relay switches connected to units to be powered off and keeping the remaining switches ON. In the shutdown state, the relay switches of all units are turned off. Particular control for each block in a unit can be implemented by reconstructing a relay switch into a plurality of systems and using not a binary signal but a multivalued control signal according to an energization state as a power supply control signal. Although a description will particularly be omitted in this embodiment, power supply is performed by such control in each power state such as a sleep state or shutdown state.

[Power Supply Monitoring of Power Supply Control Unit: Feeding Upon Boot]

Boot processing of the image forming apparatus 100 will be described next. To use the image forming apparatus 100, the operator turns on the power switch (not shown). Then, the power supply control unit 403 detects the power-ON from the power supply line J 402, and turns on the relay switches 407 and 410 by the IO signals V_ON 406 and P_ON 409. The power supply 401 thus supplies power to the overall image forming apparatus 100. The power supply control unit 403 also performs power supply corresponding to the power-ON state for the entire image forming apparatus 100. More specifically, the power supply control unit 403 energizes the main controller 110 and the optional units via DC power supply paths. In each energized optional unit, the CPU starts an initialization operation upon powering on.

When energized, the CPU 111 of the main controller 110 initializes the hardware and software. Hardware initialization includes register initialization, interrupt initialization, device driver registration upon kernel start, and initialization of the operation unit 130. Software initialization includes invocation of the initialization subroutine of each library, start of processes and threads, start of a software service to communicate with the printer unit 140 or the scanner unit 150, and rendering on the operation unit 130. The main controller 110 transits to a standby state.

[Power Supply Monitoring of Power Supply Control Unit: Feeding in Normal State]

Feeding in a normal state in which the printer unit 140 and the scanner unit 150 of the image forming apparatus 100 are not being used will be described next. Normal states include not only a state in which feeding is done for all units but also a state in which feeding to the printer unit 140 is not performed when printing is not performed and a state in which feeding to the scanner unit 150 is not performed when the operation unit 130 is not ON, and the user is known to be absent in front of the image forming apparatus 100.

[Power Supply Monitoring of Power Supply Control Unit: Feeding in Firmware Updating]

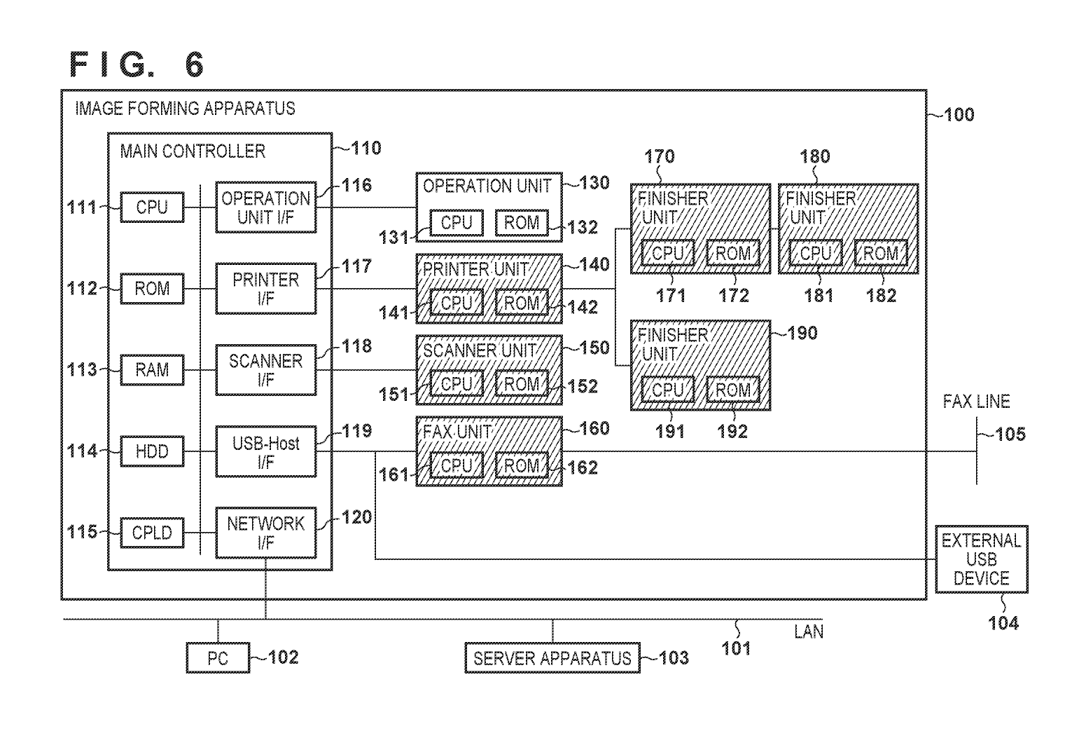

Power supply stop processing of an optional unit in firmware updating will be described next. If there is a unit determined by the power supply unit specifying unit 218 not to need power supply at the time of firmware updating, the power supply of the unit is stopped. That is, the power supply control unit 403 controls to supply power to units specified by the power supply unit specifying unit 218 to need power supply and stop power supply to the remaining units. The CPU 111 notifies the power supply control unit 403 of the transition of the power state and changes feeding to the optional units. An example of the feeding state will be described later with reference to FIG. 6.

Stop of feeding to each optional unit is implemented by, for example, controlling the relay switch for each unit, as shown in FIG. 4, to turn on only the relay switches connected to the units to stop feeding and keeping the remaining relay switches that need feeding ON.

[Processing Procedure]

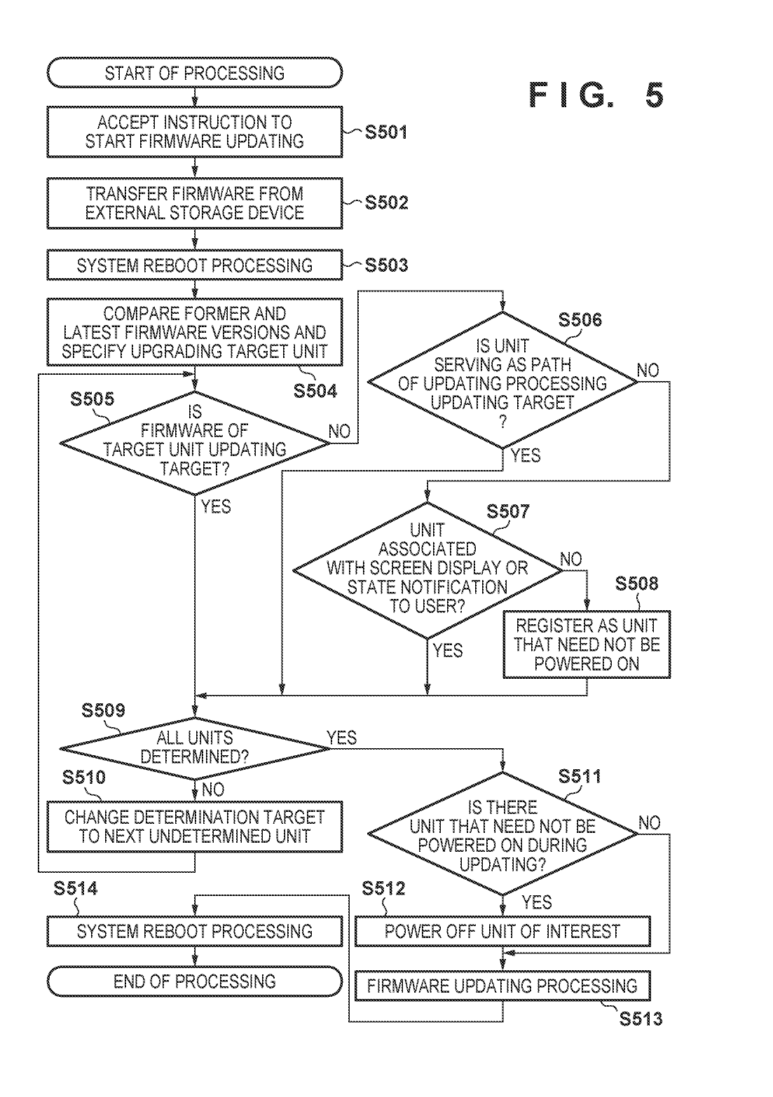

The processing procedure of the image forming apparatus 100 according to this embodiment will be described next with reference to FIG. 5. A program concerning the operation of the flowchart is stored in the ROM 112 of the main controller 110 and read out and executed by the CPU 111 to implement the operation, as described above.

In step S501, the image forming apparatus 100 accepts a firmware updating instruction. This instruction may be a user input via the operation unit 130 or may be executed by communication from the PC 102 or the server apparatus 103.

In step S502, the image forming apparatus 100 transfers the firmware file 311 to be updated from an external storage device and saves it in the HDD 114. The external storage device as the transfer source of the firmware file 311 can be either the external USB device 104 via the USB-Host I/F 119 or the PC 102 or server apparatus 103 via the network I/F 120.

In step S503, the image forming apparatus 100 performs reboot processing for firmware updating. Depending on the hardware arrangement or the like, it is impossible to select an optional unit and power it on at the stage of system boot immediately after the reboot. For this reason, all units are powered on immediately after the reboot.

In step S504, the image forming apparatus 100 causes the version comparison unit 217 to compare the contents of the firmware version list 312 included in the firmware file 311 with the version of firmware stored in each ROM. More specifically, the contents of the firmware version list 312 included in the firmware file 311 transferred in step S502 are compared with the version of firmware stored in each ROM, which is by the firmware version storage unit 216. As a result of comparison, the version comparison unit 217 specifies a unit including a ROM that stores firmware that needs updating based on the difference between the versions.

Steps S505 to S508 are steps of determination for each unit. The determination is performed by the power supply unit specifying unit 218 for each unit as a determination target.

In step S505, the image forming apparatus 100 determines whether the firmware of a target unit is the updating target as the result of version comparison in step S504. If the firmware version has no difference, that is, if the firmware is not the updating target (NO in step S505), the process advances to step S506. If the firmware version has a difference (YES in step S505), the process advances to step S509.

In step S506, the image forming apparatus 100 determines whether a unit serving as the path of updating processing is the updating target. In other words, the image forming apparatus 100 determines whether a unit located under the determination target unit on the processing path is the updating target. For example, assume that in FIG. 1, not the firmware stored in the ROM 142 of the printer unit 140 but the firmware stored in the ROM 182 of the finisher unit 180 is the updating target. In this case, the printer unit 140 and the finisher unit 170 which serve as the path need feeding. In the example of FIG. 1, for the printer unit 140, when the firmware of the printer unit itself is not the updating target, and the finisher units 170, 180, and 190 are not the updating target, the determination of step S506 ends with a “NO”. If a unit serving as the path of updating processing is the updating target (YES in step S506), the process advances to step S509. Otherwise (NO in step S506), the process advances to step S507.

In step S507, the image forming apparatus 100 determines whether the target unit is a unit associated with screen display or state notification to the user. For example, if setting is performed to do updating progress display processing, the operation unit 130 needs feeding to notify the user of the state of updating processing. Additionally, in a case in which an alarm or a unit with an alarming function is connected, and firmware as the updating target is installed as well, firmware is preferably not stopped. If the target unit is a unit associated with notification (YES in step S507), the process advances to step S509. Otherwise (NO in step S507), the process advances to step S508.

In step S508, the image forming apparatus 100 registers the target unit as a unit that need not be powered on in firmware upgrading processing.

In step S509, the image forming apparatus 100 confirms whether power supply necessity has been determined for all determination target units. If the determination of all determination target units is not completed (NO in step S509), the process advances to step S510. If the determination is completed (YES in step S509), the process advances to step S511.

In step S510, the image forming apparatus 100 changes the determination target to the next undetermined unit, and returns to step S505 to repeat the same determination as described above.

In step S511, the image forming apparatus 100 determines whether there exists a unit registered in step S508 as a unit that need not be powered on as the result of power supply determination for each unit in steps S505 to S507. If there exists a registered unit (YES in step S511), the process advances to step S512. If there exists no registered unit (NO in step S511), the process advances to step S513.

In step S512, the image forming apparatus 100 causes the power control unit 220 to communicate with the power supply control unit 403 and stop feeding to the unit by the processing described with reference to FIG. 4.

In step S513, the image forming apparatus 100 causes the program updating processing unit 219 to execute firmware updating processing using the firmware file saved in the HDD 114 for the ROM of the unit determined in step S504 to need updating.

When the firmware updating processing is completed, the image forming apparatus 100 performs reboot processing in step S514. After the boot, all units are powered on, and various functions of the image forming apparatus 100 become usable. The processing procedure thus ends.

[Detailed Example of Power Control Upon Firmware Updating]

FIG. 6 shows an example of the feeding states of the units in the processing according to the flowchart described with reference to FIG. 5 according to this embodiment. Each unit with hatching in FIG. 6 represents a unit for which feeding is stopped in step S512, that is, a unit to which no power is supplied during firmware updating processing in step S513.

FIG. 6 assumes an example in which only the ROM 112 in the main controller 110 is the firmware updating target out of the ROMs 112, 132, 142, 152, 162, 172, 182, and 192. The operation unit 130 functions as a unit used for progress display and is therefore in a feeding state.

Note that the program stored in the ROM 112 of the main controller 110 implements many functions of the image forming apparatus 100. Hence, the scale of the program in the ROM 112 is larger than those in the ROMs 132, 142, 152, 162, 172, 182, and 192 loaded by the CPUs of the optional units. For this reason, the frequency of updating to improve functions or cope with a failure tends to be high in the ROM 112, and the determination result (power control) shown in FIG. 6 is assumed to be often obtained.

The printer unit 140 and the finisher units 170, 180, and 190 include fixing units, devices for sheet conveyance, and hardware configured to perform various kinds of processing for a storage medium. If processing is continued in the feeding state, the power consumption increases. For this reason, performing control as shown in FIG. 6 is considerably advantageous from the viewpoint of power consumption. In addition, since power supply is not performed for optional units that need not be booted, neither an operation sound nor a vibration sound is generated in these optional units in firmware updating.

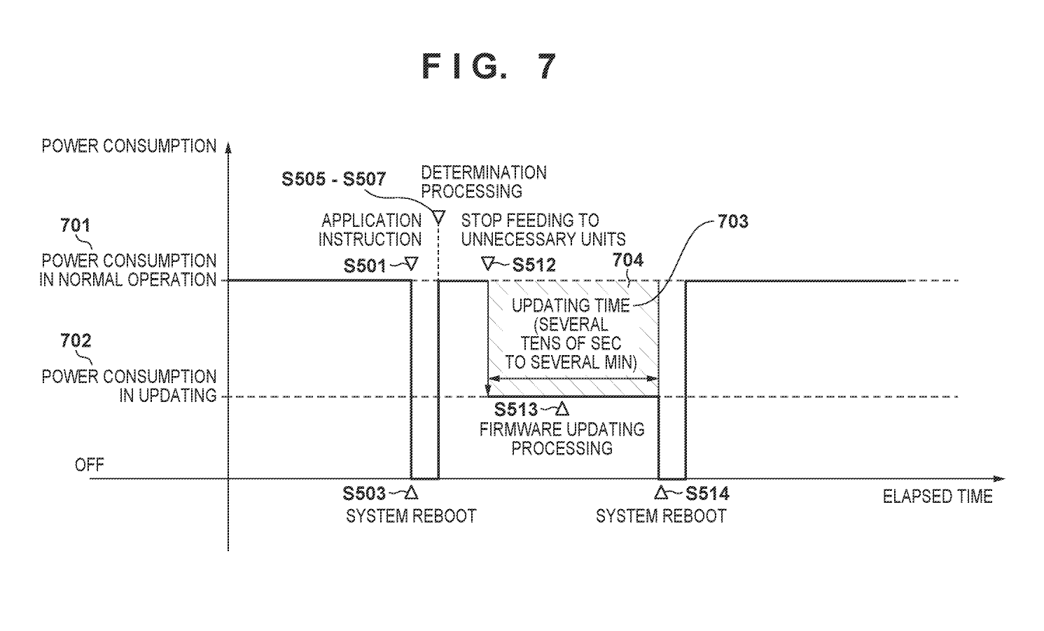

FIG. 7 shows an image of power consumption according to this embodiment. Referring to FIG. 7, the ordinate represents power consumption, and the abscissa represents elapsed time. FIG. 7 also shows timings at which the steps of the flowchart of FIG. 5 are performed.

A power consumption 701 in a normal operation is assumed to be a power consumption in a state in which all units are powered on at the time of standby, boot, or the like. A power consumption 702 in updating is assumed to be a power consumption during execution of firmware updating processing in a case in which power supply control is performed for each optional unit in this embodiment. The power consumption 702 in updating largely changes depending on updating firmware or the arrangements of the optional units of the image forming apparatus 100. FIG. 7 shows a power consumption in the power supply state shown in FIG. 6.

A firmware updating time 703 in step S513 changes depending on the processing capability of the image forming apparatus 100, the difference amount of updating firmware, the number of optional units, and the like, and is assumed to be several tens of seconds to several minutes.

A power consumption reduced by the present invention can be estimated as a hatched portion 704 in FIG. 7, that is,

((power consumption 701 in normal operation)−(power consumption 702 in updating))×(firmware updating time 703).

In an image forming apparatus including the CPU of the main controller of the main body and the CPUs of optional units that individually control optional functions such as FAX and finishing functions, the power consumption in firmware updating can be reduced in the above-described way.

Since it is dynamically determined in accordance with a state whether to stop power supply to an optional unit, appropriate power control processing can be performed. In addition, when upgrading firmware, unnecessary boot of an optional unit can be reduced. Hence, the operation sound or vibration sound in the image forming apparatus can be expected to be reduced.

### Second Embodiment

When a unit to be powered on at the time of power-ON to boot a system can freely be selected in terms of hardware arrangement, and it has no influence on the boot performance and the like of an image forming apparatus 100, the processes of steps S504 to S510 in FIG. 5 are executed before system reboot in step S503. This can further reduce the power consumption and make the effects of the first embodiment more conspicuous.

After data of firmware used for updating is transferred from an external storage device to the image forming apparatus in step S502, a unit that need not be powered on is determined in the next step, and boot unit information is stored in a nonvolatile area of a CPLD 115 before system reboot. When booting the system, the boot unit information is loaded. An optional unit that does not need power supply can be configured not to be powered on until system reboot after the end of firmware updating processing.

With this arrangement, a larger effect can be obtained from the viewpoint of power consumption as compared to the first embodiment. More specifically, the power consumption immediately after the first system reboot can be suppressed to the value of a power consumption 702 in updating shown in FIG. 7.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-077948, filed Apr. 6, 2015, which is hereby incorporated by reference herein in its entirety.

What is claimed is:

1. A system including a plurality of units each including a processing unit configured to operate using firmware, and a storage unit configured to store the firmware, comprising:
a power control unit configured to control power supply to each of the plurality of units;
an obtaining unit configured to obtain updating data of the firmware;
a first specifying unit configured to specify, based on the updating data, a unit that should update the firmware out of the plurality of units;
a second specifying unit configured to specify, out of the plurality of units, a unit that needs power supply when updating the firmware of the unit specified by the first specifying unit; and
an updating unit configured to update, using the updating data, the firmware stored in the storage unit of the unit specified by the first specifying unit,
wherein when the updating unit is updating the firmware, the power control unit supplies power to the unit specified out of the plurality of units by the second specifying unit as the unit that needs power supply, and stops power supply to remaining units.

2. The system according to claim 1, wherein the second specifying unit specifies the unit that needs power supply based on a connection configuration of the plurality of units and a position of the unit to be updated in the connection configuration.

3. The system according to claim 1, wherein the second specifying unit specifies a unit used for notification of information associated with the updating as the unit that needs power supply when the firmware is being updated.

4. The system according to claim 1, wherein when the firmware is being updated, power is supplied to a unit in which the power control unit operates.

5. The system according to claim 1, wherein the plurality of units include a plurality of optional units and a unit including a main controller configured to control the entire system, and
the second specifying unit specifies the unit including the main controller as the unit that needs power supply.

6. The system according to claim 1, wherein the system is rebooted before and after firmware updating processing by the updating unit,
the first specifying unit and the second specifying unit perform specifying before reboot performed before the firmware updating processing and store information of the specified unit in the storage unit, and
immediately after the reboot performed before the firmware updating processing, the power control unit supplies power to the unit specified out of the plurality of units as the unit that needs power supply, but does not supply power to the remaining units based on the information stored in the storage unit.

7. The system according to claim 1, wherein the obtaining unit obtains the updating data from one of an external storage device and a server on a network.

8. The system according to claim 1, wherein the obtaining unit obtains only updating data for a unit that needs firmware updating out of the plurality of units.

9. A method of controlling a system including a plurality of units each including a processing unit configured to operate using firmware, and a storage unit configured to store the firmware, and a power control unit configured to control power supply to each of the plurality of units, comprising:
obtaining updating data of the firmware;
specifying, based on the updating data, a unit that should update the firmware out of the plurality of units;
specifying, out of the plurality of units, a unit that needs power supply when updating the firmware of the unit specified in the specifying the unit that should update the firmware; and
updating, using the updating data, the firmware stored in the storage unit of the unit specified in the specifying the unit that should update the firmware,
wherein when the firmware is being updated in the updating, the power control unit is caused to supply power to the unit specified out of the plurality of units in the specifying the unit that needs power supply as the unit that needs power supply and stop power supply to remaining units.

10. A non-transitory computer-readable storage medium storing a program that causes a computer to function as:
a power control unit configured to control power supply to each of a plurality of units each including a processing unit configured to operate using firmware, and a storage unit configured to store the firmware;
an obtaining unit configured to obtain updating data of the firmware;
a first specifying unit configured to specify, based on the updating data, a unit that should update the firmware out of the plurality of units;
a second specifying unit configured to specify, out of the plurality of units, a unit that needs power supply when updating the firmware of the unit specified by the first specifying unit; and
an updating unit configured to update, using the updating data, the firmware stored in the storage unit of the unit specified by the first specifying unit,
wherein when the updating unit is updating the firmware, the power control unit supplies power to the unit specified out of the plurality of units by the second specifying unit as the unit that needs power supply, and stops power supply to remaining units.
